(19) United States
(12) Patent Application Publication
(10) Pub. No.: US 2008/0251321 A1
(43) Pub. Date: Oct. 16, 2008

(54) Safety catch for movable construction platform

(75) Inventors: Brian Clarke, Hollywood, FL (US); Christopher Gordon Cockerell, Hollywood, FL (US); Stephen Kamin, Deerfield Beach, FL (US)

Correspondence Address: YOUNG & THOMPSON, 209 Madison Street, Suite 500, ALEXANDRIA, VA, 22314, US

(73) Assignee: SAFETY GUYS, INC., FT. LAUDERDALE, FL (US)

(21) Appl. No.: 11/783,655

(22) Filed: Apr. 11, 2007

(51) Int. Cl. E04G 21/24; B66F 17/00; E04G 21/32

(52) U.S. Cl. 182/222

(57) ABSTRACT

A movable platform for supporting a load alongside a structure has an attached catch. The movable structure includes a base having an inboard side and an opposite outboard side, an inboard support extending away from the inboard side of the base, an outboard support extending away from the outboard side of the base, and a catch connected to both the inboard support and the outboard support and passing beneath the base, so that an object dropped over an inboard or outboard edge of the base will be caught by the catch. The inboard support is attached to the base so that a distal end of the inboard support is movable with respect to the base. The distal end is maintained to be in contact with the building exterior. Also described is an accessory for a preexisting movable platform that allows the arms and catch to be attached.

### BACKGROUND OF THE INVENTION

1. Field of the Invention

The present invention relates to safety accessories for use in building construction, specifically additions to structures such as swingstage scaffolds, buckhoists, and mastclimbers to prevent objects from falling to the ground below such structures.

2. Description of the Related Art

Various industries require workers to be in position on the exterior of a building, whether the building is complete or under construction. For completed buildings, various maintenance and cleaning operations necessitate that workers have access to the exterior surfaces. During construction, many operations related to both erection of the structure and treatment of exterior surfaces create similar requirements.

Necessarily, access must be provided to building exteriors from ground level up to the full height of such structures. This requires support structures to be movable vertically. This has been achieved by use of devices such as swing stage scaffolds, which are typically supported by cables attached to the roof of a building. Buckhoists and mastclimbers are known alternatives used as the need dictates.

Where the area surrounding buildings is open public space, pedestrians and automobiles are moving in and out of the area on the ground that lies directly beneath the support structures on which the workers are standing. Consequently, people are potentially in the direct path of construction materials, tools, and any other object on the support that might fall over the side.

During some construction projects, rigid temporary canopies are created to shield pedestrians from such projectiles. However, it is not always practical or even possible to put a hardened structure in place any time one or more workers is in place on the side of a structure. There remains the concern, therefore, that an object will be accidentally dropped over the side of a support structure on which an individual is working and will fall to the ground below with disastrous consequences. Even a relatively small article with comparatively low mass, if dropped from a sufficiently great height, will achieve enough momentum to cause serious injury or death if it falls upon a person below.

In addition to the concern of materials being accidentally dropped over the edge of a support structure, some dropping of materials is an almost unavoidable consequence of the construction process. One such example is the application of stucco to a building exterior. The surface texture of stucco arises from the fact that it is applied to building exteriors before it has hardened. The stucco is applied manually using a trowel in such a way so as to produce the desired texture effect. Unlike structural concrete, the stucco is not supported while it is sets.

Accordingly, at the time of application, the stucco must be sufficiently liquid so that it can be worked and shaped, yet no so thin so that it runs or falls off prior to setting. The nature of the material and the process of applying it, however, are such that as a practical matter, some amount of stucco will fall from the building surface as it is being applied. Stucco is dense material, and even when not fully set it represents a significant safety hazard when it falls from the point of application to the ground below.

Accordingly, there has arisen a need for a new support structure for workers, or an accessory for existing support structures, that can effectively prevent objects from falling to the ground below. There has also arisen the need to catch stucco and other material that falls not from the support structure on which a worker is standing, but from the building surface itself.

### SUMMARY OF THE INVENTION

The present invention addresses the problems of preventing objects from falling from a support structure and from building surfaces where workers are performing tasks. The support structure and support structure accessory of the present invention provide a catch that is positioned beneath the support structure in such a way that an object dropped from the support structure will fall into and be held by the catch. The catch can be supported along an inboard edge facing the building and along an outboard edge opposite the building. The inboard edge of the catch can be supported in such a way that it is held very close to or in contact with the building surface. The inboard edge of the catch can be held close to the building surface even as the support structure moves toward and away from the building surface.

This is particularly helpful in situations such as applying stucco. If the inboard edge of the catch is maintained in contact with or in very close proximity to the building surface, stucco that has been applied to the building surface but has fallen off will fall into the catch even as the distance between the support structure and the building surfaces changes.

In a first embodiment of the invention, a movable platform for supporting a load alongside a structure has an attached catch. The movable structure includes a base having an inboard side and an opposite outboard side, an inboard support extending away from the inboard side of the base, an outboard support extending away from the outboard side of the base, and a catch connected to both the inboard support and the outboard support and passing beneath the base, so that an object dropped over an inboard or outboard edge of the base will be caught by the catch. The inboard support is attached to the base so that a distal end of the inboard support is movable with respect to the base.

The inboard support can include a plurality of pivotally attached inboard arms. The inboard arms can be mounted so that a distal end of a given inboard arm remains above a proximal end of that inboard arm. A wheel can be attached to the distal end of each of the inboard arms. The catch can be attached to the distal end of each of inboard arms. The outboard support can also be made up of a plurality of outboard arms, in which case the catch can be attached to the distal end of each of the outboard arms. The catch can be a flexible member.

A distal end of each of the inboard arms can include a traversal mechanism. The outboard support can include a plurality of outboard arms rigidly connected to the base. The catch can be secured to the distal end of each of the inboard arms and a distal end of each of the outboard arms. The traversal mechanism can include a wheel. Alternatively, the traversal mechanism can include a skid.

A securing means can be provided for securing the flexible member to the distal end of each of the inboard and outboard arms. The securing means can include a hook disposed at the distal end of each of the inboard and outboard arms, an inboard cable connected to each of the hooks on the inboard arms, an outboard cable connected to each of the hooks on the outboard arms, and a plurality of inboard and outboard latches connected to inboard and outboard edges of the catch, respectively, the inboard latches being securable to the inboard cable, the outboard latches being securable to the outboard cable.

The catch can be made of netting. Alternatively, the catch can be made of a woven fabric.

The inboard support can be pivotably attached to the base, in which case the inboard arms can be hingedly mounted to the base. The inboard arms are constructed and arranged so that the distal end of a given one of the inboard arms is kept at least as high as proximal end of that inboard arm. The inboard arms can be constructed and arranged so that the distal end a given one of the inboard arms is kept higher than the proximal end of that inboard arm. The inboard arms can be constructed and arranged so that the inboard arm remains elevated at least 40° from horizontal.

The inboard support can include a plurality of inboard arms, each of which is axially extendable away from the base. The inboard support can include an urging element that urges a distal end of each of the inboard arms away from the base.

The invention can also take the form of a safety accessory for a preexisting movable construction platform with a base having an inboard side and an opposite outboard side. The inboard arms, outboard arms, catch, and traversal mechanism can be provided as a kit which can be mounted to a conventional swing stage scaffold, buckhoist, mastclimber, or similar device.

### BRIEF DESCRIPTION OF THE DRAWINGS

The device will be described in connection with the attached drawings, in which

FIG. 1 is a perspective view of the overall device;

FIG. 2 is a perspective view of a mechanism for attaching inboard arms to the base;

FIG. 3 is a side view of the device illustrated in FIG. 2;

FIG. 4 is a perspective view of a mechanism for attaching the outboard arm to the base;

FIG. 5 is a perspective view of the distal end of the inboard arm in a preferred embodiment;

FIG. 6 is a side view of the device shown in relation to a building with which the device makes contact; and

FIG. 7 is a side view of an alternative embodiment of an inboard arm which extends axially to accommodate differences in the distance between the base and the building.

### DESCRIPTION OF THE PREFERRED EMBODIMENTS

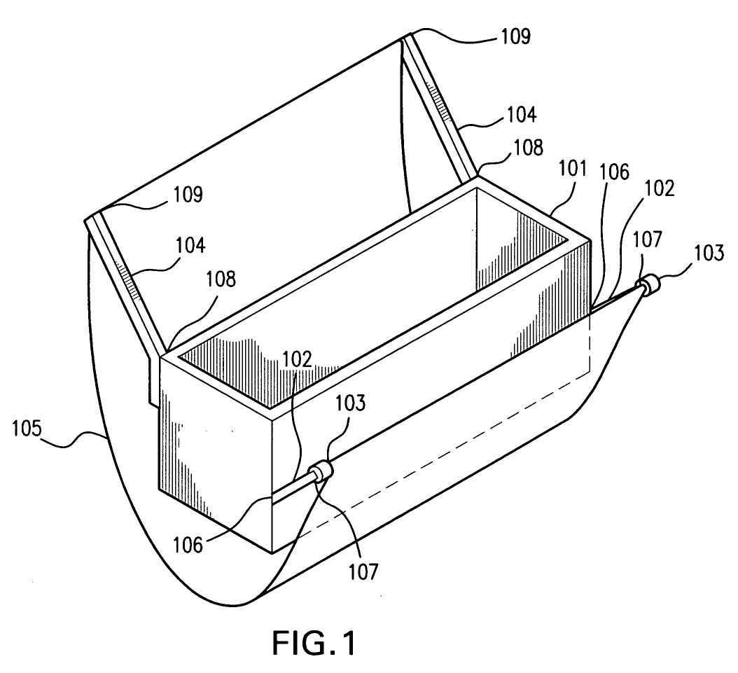

FIG. 1 provides an perspective view of a first embodiment of a movable platform according to the present invention. The platform includes a base 101, which provides the surface upon which people and/or materials are supported. The base as illustrated in FIG. 1 includes walls that surround a floor section of the base. As alternatives to walls, a railing structure, vertical netting or other similar structure that provides for a barrier to prevent people and materials from falling off of the platform may be provided. Such a barrier is not a necessary part of the present device.

The platform includes both inboard and outboard supports. The inboard supports are in the form of inboard arms 102. Each inboard arm 102 is mounted at its near or proximal end 106 to base 101 in such a way that the distance between a far or distal end 107 lies a variable distance from the base 101. This may be achieved by way of a swivel or hinge attachment between proximal end 106 and base 101. With proximal end 106 attached in this manner to base 101, as inboard arm 102 swings thorough its range of motion, distal end 107 can move up and down, and more significantly can move in and out or laterally, with respect to base 101. The device may be configured to have a single inboard arm on each end of base 101. Alternatively, a plurality of such arms 102 can be mounted along the inboard side of base 101.

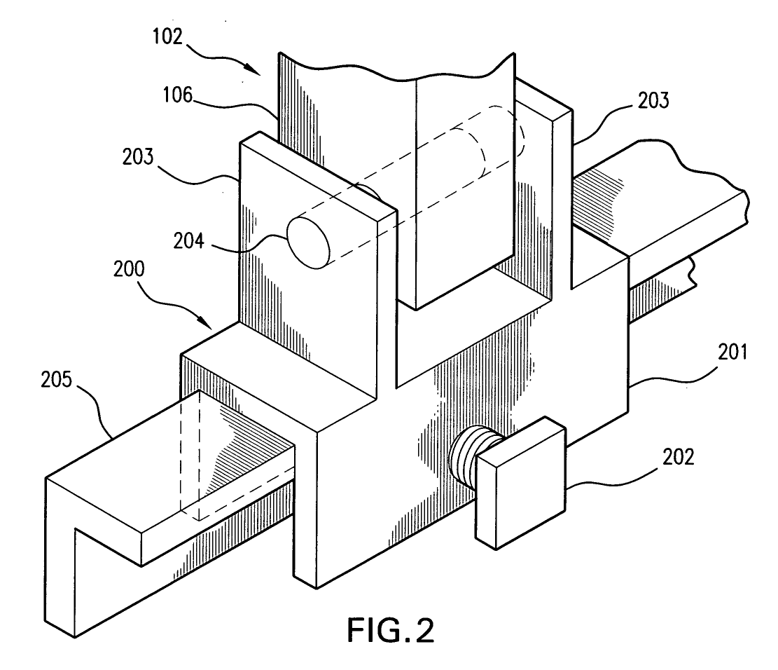

One embodiment of such a connection of proximal end 106 to base 101 appears in FIG. 2. Inboard rail 205 is an element of base 101. As illustrated, rail 205 has an L-shaped profile, although the present device can be used with rails or other elements having different profiles. Rail 205 may be an element of a protective railing structure of base 101, a component of a floor section of base 101, or other element. Inboard arm fixing element 200 provides a connection between base 101 and inboard arm 102. Inboard arm fixing element 200 includes clamp 201, arranged to partly surround inboard rail 205. Fixing bolt 202 is threaded into a corresponding aperture in clamp 201. With fixing bolt 202 removed or partially withdrawn, the clamp 201 can slide onto rail 205. By tightening down fixing bolt 202, clamp 201 is secured to inboard rail 205, and therefore to base 101. Alternative mechanisms for securing the inboard arm fixing element to base 101 are available, and include welding or mounting to an element specifically provided on base 101 for such attachment.

Two flanges 203 extend away from a side of clamp 201. Axle 204 spans the space between flanges 203 and passes through proximal end 106 of inboard arm 102. Inboard arm 102 is therefore able to pivot through a vertical arc with respect to base 101.

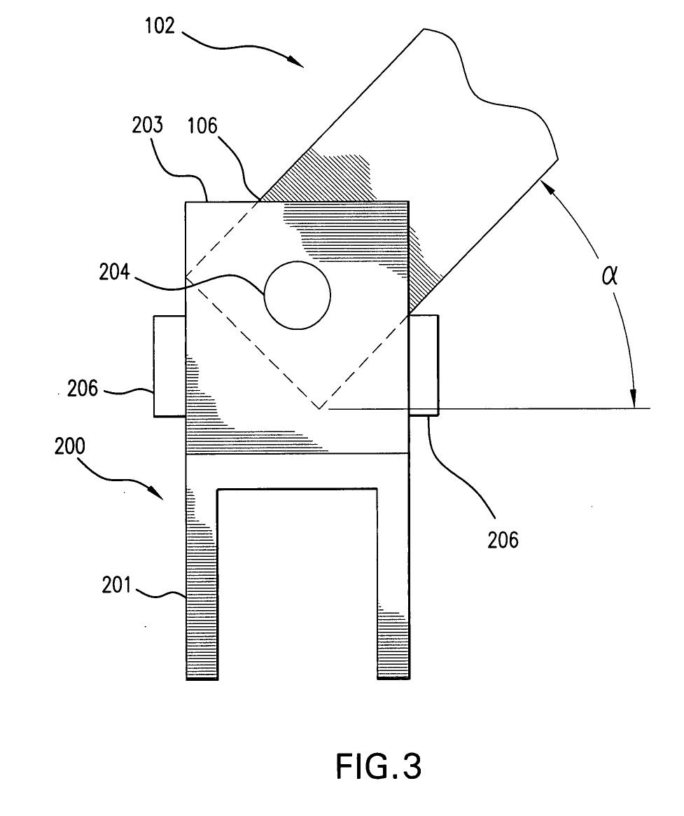

One option for clamp 201 is illustrated in FIG. 3. In some embodiments, it may be useful to attach one or more of inboard arms 102 to base 101 in such a way as to ensure that inboard arm 102 does not fall below an elevation angle α from horizontal. This can be achieved by a stop 206. Stop 206 can be mounted to span between flanges 203. With stop 206 in place, inboard arm 102 can rise to be approximately vertical, and in some embodiments beyond vertical, but cannot fall below elevation angle α. Elevation angle α can be chosen so as best to match a particular application. One such angle can be 40°. Stop 206 can also be arranged so as to provide an adjustable minimum elevation angle α. Mechanisms other than stop 206 can also be used, so long as they provide a way to maintain inboard arm 102 to have at least a certain elevation angle with respect to base 101.

The embodiment of FIG. 3 illustrates two stops 206 attached on opposite sides of fixing element 200. Inboard arm 102 can be pivoted beyond vertical until coming into contact with stop 206 on the opposite side. In this way, if clamp 201 is constructed to be mounted to an element of a particular profile that can appear in either of two orientations on various examples of base 101, fixing element 200 can be mounted with either two different orientations, as conditions require.

FIG. 1 also illustrates an outboard support in the form of outboard arms 104. Each of outboard arms 104 is fixed to an outboard side of base 101. Outboard arms 104 extend upward and outward from base 101.

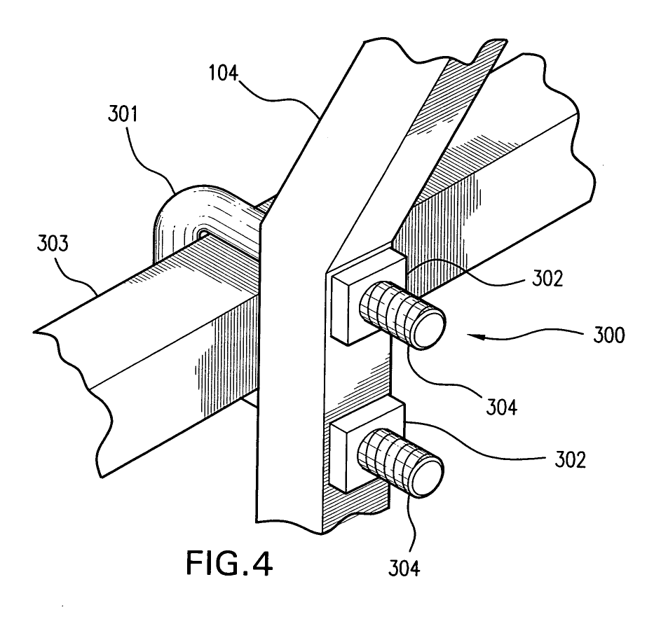

FIG. 4 illustrates one example of an attachment mechanism to secure outboard arm 104 to base 101. An outboard rail 303 runs generally horizontally along the outboard side of base 101. Outboard arm 104 is made to have two apertures passing therethrough at proximal end 108 thereof. U-bolt 301 is passed over an interior side of outboard rail 303 so that threaded ends 304 extend out beyond an exterior edge of outboard rail 303 and through the two apertures of outboard arm 104. Nuts 302 are then threaded onto respective ends 304 so as to clamp outboard arm 104 between nuts 302 and outboard rail 303.

With outboard arms 104 attached held in a fixed relationship with base 101 and inboard arms 102 movable held to base 101, catch 105 is suspended between distal ends 107 of inboard arms 102 and distal ends 109 of outboard arms 104, as illustrated in FIG. 1. Catch 105 can assume any of a number of forms. Among other materials, it can be a woven fabric, netting, or other flexible member. The requirements are that it be sufficiently strong so that an object dropped from the base 101 and caught in catch 105 will not pass or break through the material of catch 105 itself, nor will such objects break catch 105 away from any of its attachments points.

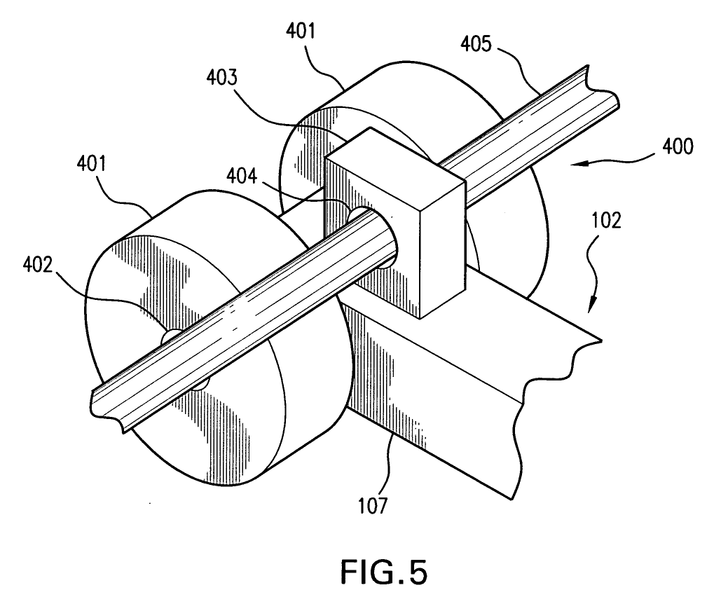

One option for attaching catch 105 to inboard arms 102 and outboard arms 104 is illustrated in FIG. 5. FIG. 5 illustrates inboard arm 102, but the same attachment mechanism can be used in connection with outboard arm 104. FIG. 5 presents a view of an underside of inboard arm 102.

Tab 403 extends out from distal end 107 of inboard arm 102. A cable 405 passes through an aperture 404 in tab 403. Cable 405 interconnects all of inboard arms 102 on the inboard side. A separate cable 405 interconnects all of outboard arms 104 on the outboard side. At the outermost inboard arm 102, cable 405 is passed through aperture 404, looped back upon itself, and secured with a cable clamp. If there are three or more inboard arms 102, cable 405 is looped back and secured at the outermost inboard arms 102, and passed through aperture 404 of each of the intermediate arms 102. Alternatively, aperture 404 can be located in inboard arm 102 itself.

By appropriately setting the attachment point and configuration of tab 403 as well as the location and dimensions of aperture 404, cable 405 will be positioned as close as possible to the surface of the building. Such positioning of cable 405 necessarily positions the inboard edge of catch 105 as near as possible to the building as well.

One category of objects that are intended to be caught by catch 105 are those that are accidentally dropped from the base 1001 itself. Another source is the building surface. As one example, during the application of stucco to the side of a building, it can be expected that some amount of stucco applied by a worker will fall away from the building surface. This falling stucco clearly presents a safety hazard. By configuring tab 403 and aperture 404 with respect to inboard arm 102 and wheels 401, cable 405 and catch 105 can be located as close as possible to the side of the building during use, thereby increasing the likelihood that stucco falling from the surface of the building will fall into catch 105.

An inboard edge of catch 105 is then secured along the cable 405 that interconnects inboard arms 102. An outboard edge of catch 105 is secured along the separate cable 405 that interconnects outboard arms 104. Catch 105 can be secured by zip ties, clips, or any other similar mechanism that provides for connection with sufficient strength and at a sufficient number of points so that an object dropped over an inboard or outboard edge of base 101 will fall into catch 105 and thereby be prevented from falling below, without tearing catch 105 away from its attachment points.

FIG. 5 also illustrates wheels 401 attached to distal end 107 of inboard arms 102. wheels 401 are mounted so as to be rotatable about axle 402. The diameter of wheels 401 and the position of axle 402 is set so that the extreme distal end of inboard arm 102 does not extend beyond a circumference of wheels 401.

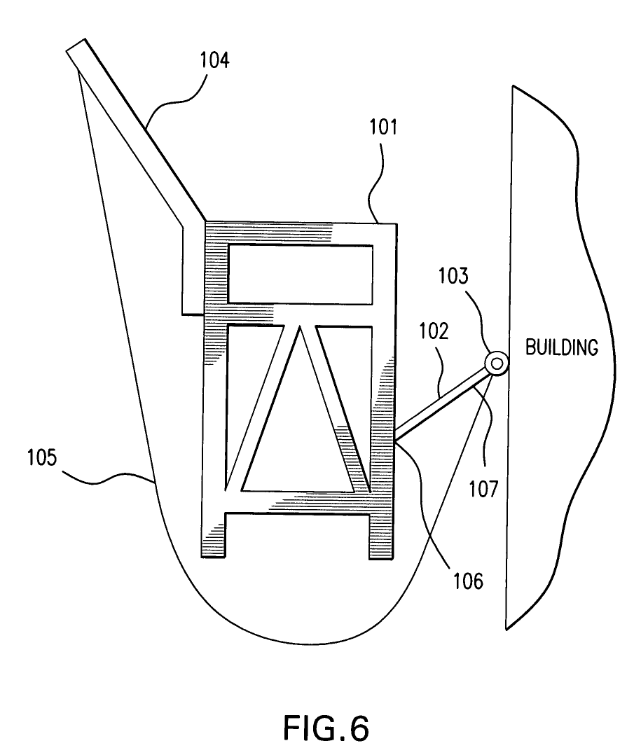

FIG. 6 illustrates how the apparatus operates in use. Base 101 can be suspended from cables secured to the roof of a building and operated as a swing-stage scaffold. Alternatively, base 101 can be an element of a mastclimber or a buckhoist. The length of inboard arm 102 is selected so that, with inboard arm 102 at its lowest elevation, wheels 401 make contact with the building when base 101 is in use. In one embodiment, inboard arms 102 are approximately 24″ long. Additionally, the length of inboard arms 102 is selected so that if base 101 moves away from the building within an anticipated range, there remains a sufficient range of motion of inboard arm 102 at its pivoting connection with base 101 that wheels 401 remain in contact with the side of the building. This has the effect of keeping an inboard edge of catch 105 in close proximity to the exterior of the building.

As catch 105 passes from its inboard edge adjacent the building to distal end 109 of outboard arm 104, catch 105 operates to prevent any object that might be dropped over the edge of base 101 from falling to the ground. Any such object will fall into catch 105 and collect at the lowest point thereof. In one embodiment, outboard arms 104 are approximately 42″ long. By having outboard arms 104 extend up and away from the outboard side of base 101, any item that may be placed near the outboard edge of base 101 and accidentally pushed over the edge will fall into catch 105.

As base 101 travels vertically up or down along the side of the building, wheels 401 roll along the surface of the side of the building. This has the effect of keeping the inboard edge of catch 105 close to the side of the building. If the base 101 swings away from the building, or the nature of the shape of the building exterior is such that the distance between base 101 and the side of the building increases as base 101 moves up or down with respect to the building, inboard arms 102 automatically adjust to keep the inboard edge of catch 105 adjacent the exterior of the building.

If the distance between base 101 and the exterior of the building increases, the weight of outboard arms 102 and the attached catch 105 pivots inboard arms 102 downward, maintaining contact between wheels 401 and the exterior of the building, up to a maximum pivoting range allowed for inboard arms 102. Alternatively, if the distance between base 101 and the exterior of the building decreases, inboard arms 102 will be forced to pivot upward, and hence closer to base 101. This also has the effect of keeping wheels 401 in contact with the building.

If the distance between base 101 and the building increases beyond the reach of inboard arm 102, inboard arm will pivot downward no farther than is allowed by stop 206. This maintains inboard arm 102 in a position in which is angled upward from horizontal, keeping distal end 107 higher than proximal end 106. In this way, if base 101 moves beyond a maximum reach of inboard arm 102, inboard arm 102 remains in its lowermost position. Catch 105 remains in a condition that it continues to be of use, as the inboard edge of catch 105 is held at a distance from the inboard edge of base 101, so that if an object were to fall over the inboard edge of base 101, such object would fall into and be trapped by catch 105. If base 101 then moves back toward the building, distal end 107 again makes contact with the side of the building and inboard arms 102 continue to keep the inboard edge of catch 105 in close proximity to the side of the building.

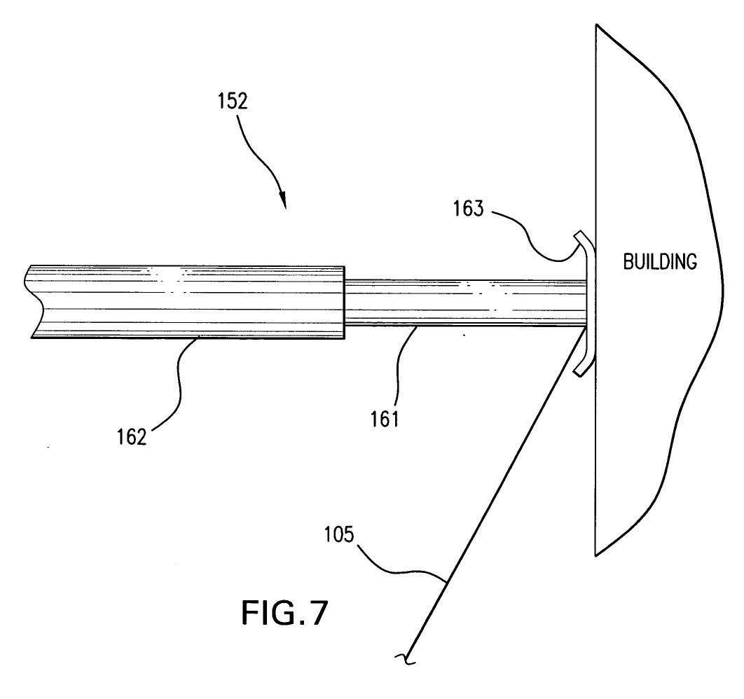

FIG. 7 illustrates an axially extendable arm 152, which can be mounted in a fixed manner to base 101. In this way the inboard edge of catch 105 is kept in close proximity to the side of the building by the distal end 157 of the axially extendable inboard arm, which automatically extends to maintain contact with the building as the distance between base 101 and the building increases and decreases. In the embodiment illustrated, extendable arm 152 is of a telescoping configuration, with distal section 161 sized to slide within proximal section 162. Axially extendable arm 152 is urged toward its most fully extended position. This may be achieved by pneumatics, spring force, or any other mechanism that serves to keep the arm in contact with the building.

Axially extendable arm 152 is shown as having a skid 163 at its distal end. The skid is meant to slide along a surface of the building as base 101 travels up or down. As base 101 swings toward or away from the building, axially extendable arm 152 contracts or expands axially to maintain skid 163 in contact with the building. The same effect results if changes in the contour of the building cause the effective distance between base 101 and the building to change as base 101 moves up or down.

If base 101 moves sufficiently far from the building so that axially extendable arm 152 reaches its position of maximum extension, the arm remains in this position and holds catch 105 away from base 101. At such time that base 101 moves back toward the building sufficiently far so that skid 163 again makes contact with the building, skid 163 returns to the condition of maintaining such contact, thereby holding the inboard edge of catch 105 in close proximity to the building.

While the various embodiments have been shown to have either one or more wheels or a skid at an outermost position of inboard arms, other implementations are possible. Also, the pivoting and fixed but axially extending embodiments for attachment of inboard arms to the base can be replaced with other embodiments and remain within the scope of the present invention. In any event, the inboard arms are to be implemented in such a way that a distal end of the inboard arm can remain in contact or close proximity with the building as the base and building surface move laterally and vertically with respect to one another. Whatever device is used to terminate the inboard arm should provide for contact between the distal end of the inboard arm and the building without catching or binding.

1. A movable platform for supporting a load alongside a structure, the movable platform having an attached catch, comprising:
a base having an inboard side and an opposite outboard side;
an inboard support extending away from the inboard side of the base;
an outboard support extending away from the outboard side of the base; and
a catch connected to both the inboard support and the outboard support and passing beneath the base, so that an object dropped over an inboard or outboard edge of the base will be caught by the catch, wherein the inboard support is attached to the base so that a distal end of the inboard support is movable with respect to the base.

2. The movable platform of claim 1, wherein the inboard support comprises a plurality of pivotally attached inboard arms.

3. The movable platform of claim 2, wherein the inboard arms are mounted so that a distal end of a given said inboard arm remains above a proximal end of the given inboard arm.

4. The movable platform of claim 3, further comprising a wheel attached to the distal end of each of the inboard arms.

5. The movable platform of claim 4, wherein the catch is attached to the distal end of each of inboard arms.

6. The movable platform of claim 5, wherein the outboard support comprises a plurality of outboard arms.

7. The movable platform of claim 6, wherein the catch is attached to the distal end of each of the outboard arms.

8. The movable platform of claim 7, wherein the catch is a flexible member.

9. The movable platform of claim 1, wherein the inboard support comprises a plurality of inboard arms.

10. The movable platform of claim 9, wherein a distal end of each of the inboard arms comprises a traversal mechanism.

11. The movable platform of claim 10, wherein the outboard support comprises a plurality of outboard arms rigidly connected to the base.

12. The movable platform of claim 11, wherein the catch is secured to the distal end of each of the inboard arms and a distal end of each of the outboard arms.

13. The movable platform of claim 12, further comprising securing means for securing the flexible member to the distal end of each of the inboard and outboard arms, the securing means comprising:
a hook disposed at the distal end of each of the inboard and outboard arms;
an inboard cable connected to each of the hooks on the inboard arms;
an outboard cable connected to each of the hooks on the outboard arms; and
a plurality of inboard and outboard latches connected to inboard and outboard edges of the catch, respectively, the inboard latches being securable to the inboard cable, the outboard latches being securable to the outboard cable.

14. The movable platform of claim 13, wherein the catch comprises netting.

15. The movable platform of claim 13, wherein the catch comprises a woven fabric.

16. The movable platform of claim 10, wherein the traversal mechanism comprises a wheel.

17. The movable platform of claim 10, wherein the traversal mechanism comprises a skid.

18. The movable platform of claim 10, wherein the inboard support is pivotably attached to the base.

19. The movable platform of claim 18, wherein the inboard arms are hingedly mounted to the base.

20. The movable platform of claim 19, wherein the inboard arms are constructed and arranged so that the distal end of a given one of the inboard arms is kept at least as high as proximal end of the given inboard arm.

21. The movable platform of claim 20, wherein the inboard arms are constructed and arranged so that the distal end a given one of the inboard arms is kept higher than the proximal end of the given inboard arm.

22. The movable platform of claim 21, wherein each of the inboard arms is constructed and arranged so that the inboard arm remains elevated at least 40° from horizontal.

23. The movable platform of claim 10, wherein the inboard support comprises a plurality of inboard arms, each axially extendable away from the base.

24. The movable platform of claim 23, wherein the inboard support comprise an urging element that urges a distal end of each of the inboard arms away from the base.

25. A safety accessory for a movable construction platform with a base having an inboard side and an opposite outboard side, comprising:
an inboard support having means for attachment to the base so as to extend away from the inboard side of the base;
an outboard support having means for attachment to the base so as to be extending away from the outboard side of the base; and
a catch having means for connection to both the inboard support and the outboard support so that the catch will pass beneath the base, so that an object dropped over an inboard or outboard edge of the base will be caught by the catch, wherein the inboard support means for attachment allows a distal end of the inboard support to be movable with respect to the base.
